(19) United States
(12) Patent Application Publication
(10) Pub. No.: US 2026/0211152 A1
(43) Pub. Date: Jul. 23, 2026

(54) EXPERIMENTAL DEVICES FOR ANALYZING SEISMIC DAMAGE TO SLOPES UNDER COUPLED ACTION OF GROUND MOTION AND BEDROCK DISLOCATION

(71) Applicants: INSTITUTE OF DISASTER PREVENTION, Sanhe (CN); BEIJING DISASTER PREVENTION TECHNOLOGY CO., LTD., Beijing (CN)

(72) Inventors: Jianyi ZHANG, Beijing (CN); Jianke MA, Sanhe (CN); Jun GU, Sanhe (CN); Yijie SONG, Sanhe (CN); Ziyi FENG, Sanhe (CN)

(73) Assignees: INSTITUTE OF DISASTER PREVENTION, Sanhe (CN); BEIJING DISASTER PREVENTION TECHNOLOGY CO., LTD., Beijing (CN)

(21) Appl. No.: 19/455,791

(22) Filed: Jan. 21, 2026

(30) Foreign Application Priority Data
Jan. 21, 2025 (CN) 202510088366.7

(51) Int. Cl. G01V 20/00

(52) U.S. Cl. CPC G01V 20/00

(57) ABSTRACT

Provided is an experimental device for analyzing seismic damage to a slope under coupled action of ground motion and bedrock dislocation. The experimental device includes a seismic motion excitation system and a bedrock fault dislocation system. The seismic motion excitation system includes a shaking table, a shaking table platen, a plurality of vertical actuators, and a horizontal actuator, enabling bidirectional seismic motion input. The bedrock fault dislocation system includes a lifting box, a fixed box, a slope adjustment actuator, inclination adjustment reaction devices, and pushing actuators. A required slope gradient is achieved by jacking up the lifting box using the slope adjustment actuator, and relative fault dislocation is realized by pushing a movable bottom plate of the lifting box using the pushing actuators. Operating the seismic motion excitation system and the bedrock fault dislocation system simultaneously enables experimental analysis of seismic damage to a slope under coupled action of ground motion and bedrock dislocation.

### CROSS-REFERENCE TO RELATED APPLICATIONS

This application claims priority to Chinese Patent Application No. 202510088366.7, filed on Jan. 21, 2025, the entire contents of which are incorporated herein by reference.

### TECHNICAL FIELD

The present disclosure relates to the field of large-scale slope model testing under seismic action, and in particular, to an experimental device for analyzing seismic damage to a slope under coupled action of ground motion and bedrock dislocation.

### BACKGROUND

Extensive post-earthquake investigations indicate that earthquake-induced slope instability and sliding constitute one of the primary seismic geological hazards in mountainous and hilly regions. Seismic slope instability is characterized by wide distribution, large numbers, and significant destructiveness, constituting a major secondary disaster that results in casualties and economic losses. In the vicinity of major seismic fault zones, ground motion intensity is high, and slopes are densely distributed. Slopes directly “cut” by relative fault dislocation or the relative movement of the fault blocks suffer even more severe damage. Slope failure under the combined action of ground motion and bedrock dislocation has become an urgent problem to solve, and indoor model testing is one of the effective manners for investigating seismic slope instability.

Current research by numerous scholars on seismic slope model testing exhibits the following shortcomings. First, most manners involve placing the slope model on a shaking table without considering the impact of bedrock fault dislocation, especially multi-angle dislocation, on slope instability. Second, the preparation of slope models with different gradients has traditionally been cumbersome and complex, and the performance of the slope models in simulating real stress conditions is generally poor. Finally, slope models are often too small in scale to authentically reproduce the process of slope failure and instability under seismic action.

Therefore, it is necessary to provide an experimental device for analyzing seismic damage to a slope under coupled action of ground motion and bedrock dislocation. The experimental device simulates the failure and instability of a slope with a certain gradient under the action of ground motion and fault dislocation at different inclination angles, thereby promoting the development and innovation of dynamic theory for slopes under seismic action.

### SUMMARY

One or more embodiments of the present disclosure provide an experimental device for analyzing seismic damage to a slope under coupled action of ground motion and bedrock dislocation. The experimental device includes a seismic motion excitation system based on a shaking table and a bedrock fault dislocation system arranged on the seismic motion excitation system.

The seismic motion excitation system includes the shaking table, a shaking table platen, a plurality of vertical actuators, and a horizontal actuator. The plurality of vertical actuators are arranged on a lower surface of the shaking table platen. The horizontal actuator is arranged at an end of the shaking table platen. The plurality of vertical actuators and the horizontal actuator are fixed to the shaking table. The seismic motion excitation system is configured to realize bidirectional seismic motion input.

The bedrock fault dislocation system includes a lifting box and a fixed box. The fixed box is fixed to the shaking table platen. The lifting box and the fixed box are hingedly connected with each other. The lifting box is provided with a slope adjustment actuator configured to jack up the lifting box to achieve a required slope gradient. A bottom plate of the lifting box includes a movable bottom plate and a fixed bottom plate. A relative fault dislocation is achieved by pushing the movable bottom plate of the lifting box with pushing actuators.

The lifting box further includes a rear plate and side plates. The movable bottom plate is located at a rear side of the lifting box. The fixed bottom plate is located at a front side of the lifting box. Installation gaps are reserved between the movable bottom plate and each of the fixed bottom plate, the side plates, and the rear plate. Each of four corners of a bottom portion of the movable bottom plate is provided with angle steels. Each end of the fixed bottom plate is fixedly connected to one of the side plates. A front end of the fixed bottom plate is provided with a bearing hinge interface configured to be hingedly connected to the fixed box. Each of the side plates is provided with a support bracket hingedly connected to the slope adjustment actuator, and a bottom portion of the slope adjustment actuator is locked to the shaking table platen via fasteners, and hoisting rings are fixed to reinforcing ribs at four corners of an upper portion of the side plates.

The fixed box includes a front box plate, fixed side plates, and a bottom plate. The front box plate, the fixed side plates, and the bottom plate are fixedly connected to each other as a whole and locked to the shaking table platen via fasteners, a rear end of the bottom plate is provided with a hinge bearing device configured to be hingedly connected to the bearing hinge interface at the front end of the lifting box, and the bottom plate is connected to the shaking table platen via the fasteners.

After the lifting box is raised, the side plates of the lifting box are embedded within the fixed side plates of the fixed box.

And inclination adjustment reaction devices are locked to the shaking table platen via fasteners and located below the movable bottom plate of the lifting box. Each of the inclination adjustment reaction devices is provided with multi-angle holes, a bottom portion of each of the pushing actuators is detachably connected to the multi-angle holes, and a top portion of the pushing actuator is detachably connected to a hinge head at the bottom portion of the movable bottom plate of the lifting box. Counts of the inclination adjustment reaction devices and the pushing actuators are four.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering denotes the same structure.

FIG. 1 is a front view of an experimental device for analyzing seismic damage to a slope under coupled action of ground motion and bedrock dislocation according to some embodiments of the present disclosure;

FIG. 2 is a schematic diagram illustrating a structure of a lifting box according to some embodiments of the present disclosure;

FIG. 3 is a schematic diagram illustrating a structure of a bottom plate of a lifting box according to some embodiments of the present disclosure;

FIG. 4 is a schematic diagram illustrating a structure of a fixed box according to some embodiments of the present disclosure; and

FIG. 5 is a schematic diagram illustrating a structure of an inclination adjustment reaction device according to some embodiments of the present disclosure.

### REFERENCE NUMERALS

1: shaking table; 2: lifting box; 3: fixed box; 4: slope adjustment actuator; 5: inclination adjustment reaction device; 6: pushing actuator; 7: fastener; 8: fixed steel rod; 9: rolling guide mechanism; 10: damper; 11: pressure sensor; 12: control terminal; 101: shaking table platen; 102: vertical actuator; 103: horizontal actuator; 201: rear plate; 202: side plate; 203: movable bottom plate; 204: fixed bottom plate; 205: angle steel; 206: support bracket; 207: hoisting ring; 208: bearing hinge interface; 209: hinge head; 301: front box plate; 302: fixed side plate; 303: bottom plate; 304: hinge bearing device; 501: multi-angle holes.

### DETAILED DESCRIPTION

Below is a brief description of the accompanying drawings required for the description of the embodiments. The accompanying drawings do not represent all implementations.

Unless the context clearly indicates otherwise, the terms “a,” “an,” “a kind of,” and/or “the” are not limited to the singular form and may also include the plural form. In general, the terms “include” and “comprise” merely indicate the inclusion of explicitly identified steps and elements. These steps and elements do not constitute an exhaustive enumeration, and the method or device may also include other steps or elements.

It should be understood that for the convenience of describing the present disclosure, terms indicating positional relationships such as “center,” “upper surface,” “lower surface,” “upper,” “lower,” “top,” “bottom,” “inner,” “outer,” “axial,” “radial,” “periphery,” and “external” are based on the positional relationships shown in the accompanying drawings. They are not intended to indicate that the referenced apparatus, component, or unit must have a specific positional relationship, nor should they be construed as limiting the present disclosure. However, if other expressions can achieve the same purpose, the described expressions may be replaced by those other expressions.

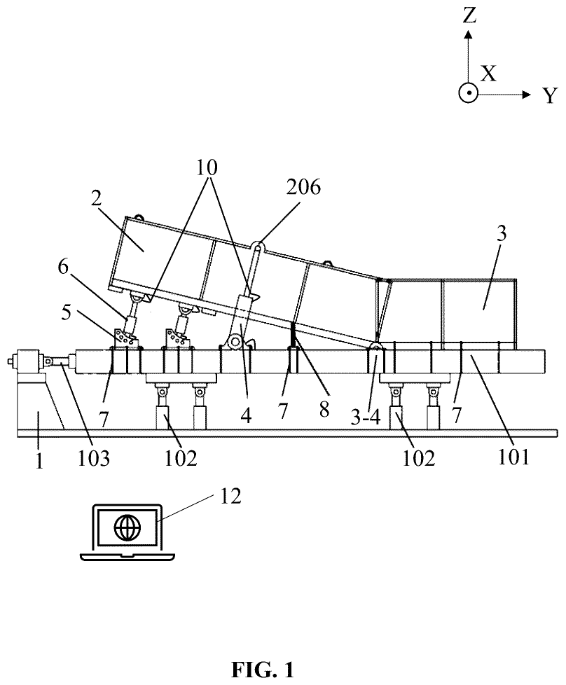

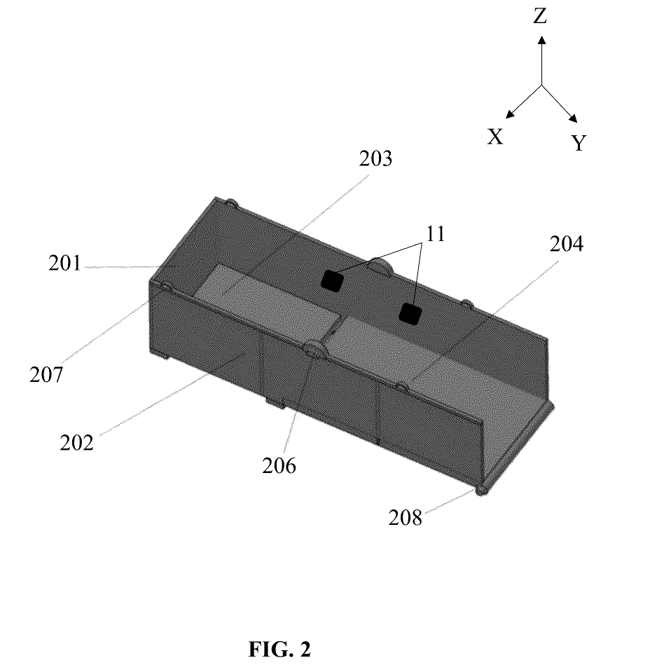

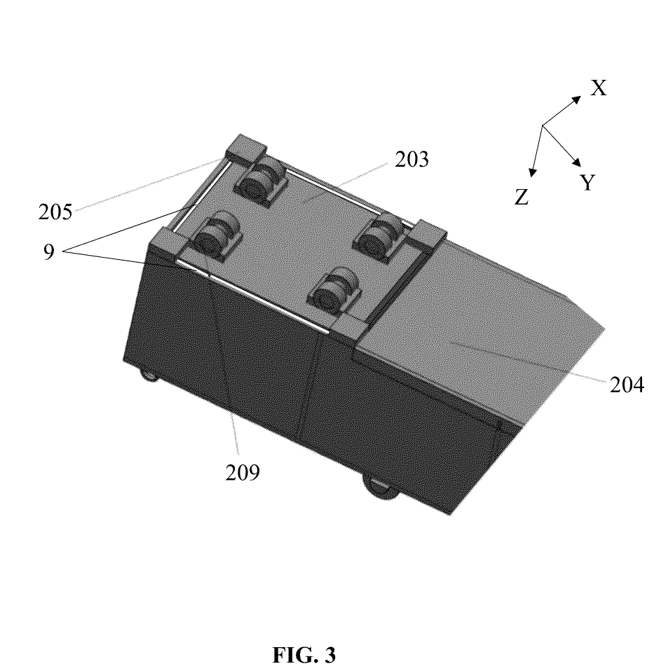

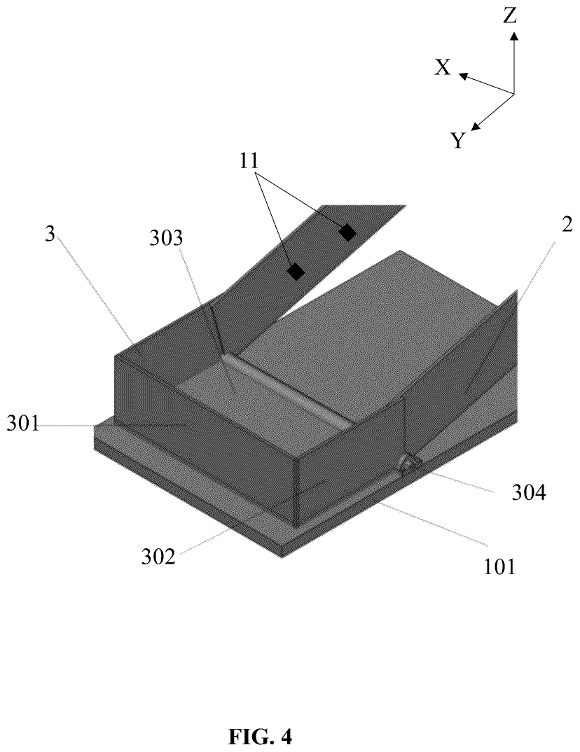

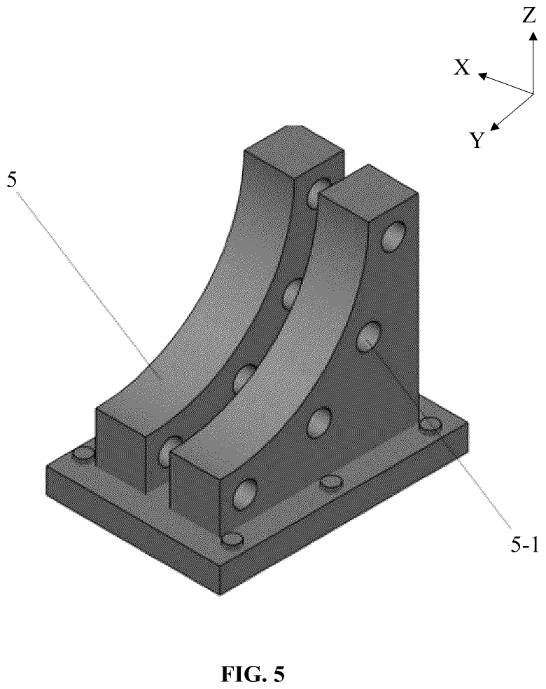

FIG. 1 is a front view of an experimental device for analyzing seismic damage to a slope under coupled action of ground motion and bedrock dislocation according to some embodiments of the present disclosure. FIG. 2 is a schematic diagram illustrating a structure of a lifting box according to some embodiments of the present disclosure. FIG. 3 is a schematic diagram illustrating a structure of a bottom plate of a lifting box according to some embodiments of the present disclosure. FIG. 4 is a schematic diagram illustrating a structure of a fixed box according to some embodiments of the present disclosure. FIG. 5 is a schematic diagram illustrating a structure of an inclination adjustment reaction device according to some embodiments of the present disclosure.

As shown in FIGS. 1 to 5, the experimental device for analyzing seismic damage to a slope under coupled action of ground motion and bedrock dislocation includes a seismic motion excitation system based on a shaking table 1 and a bedrock fault dislocation system arranged on the shaking table 1.

The seismic motion excitation system is configured to simulate the “severe ground shaking” (i.e., ground motion) that occurs during an actual earthquake.

The seismic motion excitation system includes the shaking table 1, a shaking table platen 101, a plurality of vertical actuators 102, and a horizontal actuator 103. The seismic motion excitation system is configured to realize bidirectional seismic motion input.

The shaking table 1 is a core load-bearing and driving apparatus of the seismic motion excitation system.

The shaking table platen 101 refers to a platform located at an upper portion of the shaking table 1. The shaking table platen 101 is a working surface for directly placing the bedrock fault dislocation system. The shaking table platen 101 may receive thrust from actuators and generate motion. The actuators refer to driving devices that convert energy (e.g., electrical or hydraulic energy) into mechanical linear or rotary motion. For example, the actuators may be hydraulic cylinders, electric cylinders, or the like. In some embodiments, the actuators include the plurality of vertical actuators 102 and the horizontal actuator 103.

In some embodiments, the plurality of vertical actuators 102 are arranged on a lower surface of the shaking table platen 101, and the horizontal actuator 103 is arranged at an end of the shaking table platen 101.

The lower surface of the shaking table platen refers to a surface of the shaking table platen 101 that is away from a lifting box. The end of the shaking table platen refers to an end of the shaking table platen 101 that is away from a fixed box. For example, the end of the shaking table platen 101 may be a left end or a right end, which may be set according to actual requirements.

The vertical actuators 102 refer to actuators installed perpendicular to the ground. The vertical actuators 102 may be configured to drive the shaking table platen 101 to produce up- and-down (vertical) motion, thereby simulating a vertical component of an earthquake.

The horizontal actuator 103 refers to an actuator installed horizontally relative to the ground. The horizontal actuator 103 may be configured to drive the shaking table platen 101 to produce motion in a horizontal direction (e.g., along a positive X-axis direction or a negative X-axis direction, or along a positive Y-axis direction or a negative Y-axis direction), thereby simulating a horizontal component of the earthquake.

In some embodiments, the plurality of vertical actuators 102 and the horizontal actuator 103 are fixed to the shaking table 1. The fixation between the plurality of vertical actuators 102, the horizontal actuator 103, and the shaking table 1 may be achieved by any feasible manners, such as flange connection, direct threaded connection, or the like.

The bidirectional seismic motion input refers to a loading mode in which the horizontal actuator 103 and the plurality of vertical actuators 102 cooperatively drive the shaking table platen 101, enabling the shaking table platen 101 to independently and synchronously reproduce an acceleration time history of real seismic ground motion in two orthogonal directions, i.e., a horizontal direction and a vertical direction.

The bedrock fault dislocation system is configured to simulate a co-seismic displacement of a bedrock fault that occurs during an actual earthquake and transmission effect of the co-seismic displacement on overlying strata.

The bedrock fault dislocation system is arranged on the shaking table 1. The bedrock fault dislocation system may include the lifting box 2, the fixed box 3, a slope adjustment actuator 4, inclination adjustment reaction devices 5, and pushing actuators 6. The lifting box 2 and the fixed box 3 are hingedly connected with each other. The lifting box 2 is provided with the slope adjustment actuator 4. The slope adjustment actuator 4 is configured to jack up the lifting box 2 to achieve a required slope gradient. The pushing actuators 6 are configured to push a movable bottom plate 203 of the lifting box 2 to achieve a relative fault dislocation.

The lifting box 2 refers to a box structure used for containing and constructing geotechnical body of a slope model. The slope model refers to a physical entity set up to simulate a real natural slope or an engineering slope (e.g., a highway cut, a reservoir bank slope, or an open-pit mine).

In some embodiments, a material of the lifting box 2 may include low-alloy structural steel plate such as Q345B (a grade of low-alloy steel with a minimum yield strength of 345 MPa) or higher-strength grades.

A front side of the lifting box 2 refers to a side of the lifting box 2 that is closer to the fixed box 3. A rear side of the lifting box 2 refers to a side of the lifting box 2 that is away from the fixed box 3.

In some embodiments, as shown in FIGS. 1 to 3, the lifting box 2 includes a rear plate 201, side plates 202, a movable bottom plate 203, a fixed bottom plate 204, angle steels 205, support brackets 206, and hoisting rings 207. The movable bottom plate 203 is located at the rear side of the lifting box 2, and the fixed bottom plate 204 is located at the front side of the lifting box 2. Installation gaps are reserved between the movable bottom plate 203 and each of the fixed bottom plate 204, the side plates 202, and the rear plate 201. Each of four corners of a bottom portion of the movable bottom plate 203 is provided with the angle steel 205.

The rear plate 201, the side plates 202, and the bottom plate may be plates located at a rear end (an end away from the fixed box 3 along the negative Y-axis direction), two sides (along an X-axis direction), and a bottom portion (along a negative Z-axis direction) of the lifting box 2, respectively. The movable bottom plate 203 refers to a bottom plate close to the rear plate 201, and the fixed bottom plate 204 refers to a bottom plate away from the rear plate 201.

The installation gaps refer to a tiny clearance reserved between the movable bottom plate 203 and all surrounding fixed components, including the side plates 202, the rear plate 201, and the fixed bottom plate 204.

In some embodiments, each end of the fixed bottom plate 204 is fixedly connected to one of the side plates 202. A front end of the fixed bottom plate 204 is provided with a bearing hinge interface 208 configured to be hingedly connected to the fixed box 3.

In some embodiments, fixed connection between the fixed bottom plate 204 and the side plates 202 may be achieved by a plurality of ways, such as welding, riveting, bonding, or the like. Merely by way of example, the fixed bottom plate 204 is welded together with the side plates 202 as an integrated structure.

A front end of the fixed bottom plate 204 refers to an end of the fixed bottom plate 204 along a Y-axis direction that is configured to connect to the fixed box 3.

The bearing hinge interface refers to an installation interface provided at the front end of the fixed bottom plate 204.

In some embodiments, each of the side plates 202 is provided with the support bracket 206. The support bracket 206 is hingedly connected to the slope adjustment actuator 4. A bottom portion of the slope adjustment actuator 4 is locked to the shaking table platen 101 via fasteners 7.

In some embodiments, the support brackets 206 may be a portion of the side plates 202, integrally formed with the side plates 202. In some embodiments, the support brackets 206 may be separate components fixed to the side plates 202 by means such as bonding, fastener connection, or the like. Merely by way of example, the support brackets 206 on both sides of the lifting box 2 are fixed by welding to reinforcing ribs of the side plates 202. The reinforcing ribs refer to relatively small and thick steel plates or section steels additionally welded onto a surface of a main structural plate (such as the side plates). In some embodiments, the reinforcing ribs may also be referred to as steel stiffening rib. The reinforcing ribs are configured to reinforce and stabilize a large-area thin plate or structure, preventing local instability deformation under load.

In some embodiments, the hoisting rings 207 are fixed to the reinforcing ribs at four corners of an upper portion of the side plates 202. Fixation between the hoisting rings 207 and the side plates 202 may be achieved by a plurality of ways, such as welding, bonding, or the like. Merely by way of example, the hoisting rings 207 are welded to the reinforcing ribs at four corners of the upper portion of the side plates 202 of the lifting box 2.

In some embodiments, lubrication material layers are coated on contact surfaces between the movable bottom plate 203 and each of the side plates 202 and the rear plate 201. In some embodiments, as shown in FIG. 3, rolling guide mechanisms 9 are arranged at the installation gaps between the movable bottom plate 203 and each of the side plates 202 and the rear plate 201.

The contact surfaces between the movable bottom plate 203 and each of the side plates 202 refer to side surfaces of the movable bottom plate 203. The contact surface between the movable bottom plate 203 and the rear plate 201 refers to a rear end surface of the movable bottom plate 203 (an end surface close to the rear plate 201).

The lubrication material layers refer to a friction-reducing coating applied on the contact surfaces. A material of the lubrication material layers may include polytetrafluoroethylene (PTFE), molybdenum disulfide, or the like.

In some embodiments, the lubrication material layers may be obtained by selecting solid lubricants such as PTFE or molybdenum disulfide and applying processes such as spraying or sintering to form a continuous film.

The rolling guide mechanisms refer to mechanical components installed at the installation gaps, converting sliding friction into rolling friction. For example, the rolling guide mechanisms may be standardized linear guide assemblies or slide rail assemblies.

In some embodiments, the rolling guide mechanisms may be fixed to the side plates 202 and the rear plate 201, or may be fixed to edges of the movable bottom plate 203 that contact the side plates 202 and the rear plate 201.

In some embodiments of the present disclosure, by reducing the frictional resistance during the movement of the movable bottom plate, the smoothness and precision of the bedrock dislocation action are ensured, thereby avoiding test errors caused by jamming and simultaneously reducing the load loss of the actuators.

The bottom portion of the movable bottom plate 203 refers to a surface of the movable bottom plate 203 along the negative Z-axis direction.

The angle steels refer to steel members used to fix the movable bottom plate 203 and prevent the movable bottom plate 203 from falling off. In some embodiments, the angle steels may also be referred to as high-strength angle steels. High strength means that yield strength and tensile strength of the material are significantly higher than those of ordinary carbon structural steel angle steel. The yield strength refers to stress that a material is capable of withstanding when the material starts to undergo unrecoverable permanent plastic deformation (i.e., yielding) under force. The tensile strength refers to maximum stress that a material is capable of withstanding before fracturing in a tensile test.

In some embodiments, the four angle steels 205 support four corners of a bottom portion of the lifting box 2, i.e., the four angle steels 205 support four corners of the bottom portion of the movable bottom plate 203 of the lifting box 2. Support refers to a type of constraint between the angle steels and the movable bottom plate 203: the angle steels primarily bear forces transmitted from the movable bottom plate 203 along a specific direction (i.e., a direction perpendicular to a normal direction of the movable bottom plate 203), but impose little or no restriction on the movement of the movable bottom plate 203 in other directions.

The support brackets 206 refer to high-strength steel structural members disposed on outer sides of the side plates. The support brackets 206 are configured to connect the slope adjustment actuator 4 with the lifting box 2.

The hoisting rings 207 refer to steel structural members disposed at four corners of the upper portion of the lifting box 2. A shape of each of the hoisting rings 207 may be annular, U-shaped, or the like.

The fasteners 7 refer to mechanical portions configured to connect two or more portions together in a detachable manner. In some embodiments, the fasteners 7 may include high-strength bolts and nuts. The high-strength bolts refer to bolts with a property class not lower than grade 8.8, that is, a nominal tensile strength of each of the high-strength bolts is not less than 800 MPa and a minimum yield strength of each of the high-strength bolts is not less than 640 MPa. The high-strength nuts refer to nuts used in conjunction with the high-strength bolt, whose proof load stress meets a corresponding high-strength grade standard (e.g., grade 8 or 10). Accordingly, a fastener whose mechanical property indices are lower than the aforementioned standards is defined as an ordinary fastener. The nominal tensile strength refers to maximum stress that a bolt is capable of withstanding before fracture. The minimum yield strength refers to minimum stress that the bolt begins to undergo permanent plastic deformation. The high-strength grade standard refers to a property class of the nut and a corresponding proof load requirement of the nut.

The fixed box 3 refers to a box structure adjacent to the lifting box 2 and fixed to the shaking table platen 101.

In some embodiments, the fixed box 3 includes a front box plate 301, fixed side plates 302, and a bottom plate 303. The front box plate 301, the fixed side plates 302, and the bottom plate 303 are mutually fixedly connected to each other as a whole and locked to the shaking table platen 101 via the fasteners 7. A rear end of the bottom plate 303 is provided with a hinge bearing device 304. The hinge bearing device 304 is configured to be hingedly connected to the bearing hinge interface 208 at the front end of the fixed bottom plate 204 of the lifting box 2. The bottom plate 303 is connected to the shaking table platen 101 via the fasteners 7. After the lifting box 2 is raised, the side plates 202 of the lifting box 2 are embedded within the fixed side plates 302 of the fixed box 3.

The front box plate 301, the fixed side plates 302, and the bottom plate 303 refer to plates located at a front end (i.e., an end away from the lifting box 2 along the Y-axis direction), two sides (along the X-axis direction), and a bottom portion (along the negative Z-axis direction) of the fixed box 3, respectively.

Mutual fixed connection among the front box plate 301, the fixed side plates 302, and the bottom plate 303 may be achieved by a plurality of ways, such as welding, fastener connection, bonding, or the like.

The rear end of the bottom plate 303 refers to an end of the bottom plate 303 that faces the lifting box 2 along the negative Y-axis direction.

The hinge bearing device 304 refers to a bearing mechanism installed at the rear end of the bottom plate 303. The hinge bearing device 304 may be used for hinged connection with the lifting box 2 to form a rotation center.

Embedded refers to a fitting relationship between the side plates 202 of the lifting box 2 and the fixed side plates 302 of the fixed box 3. That is, after the lifting box 2 is raised, the side plates 202 of the lifting box 2 are nested between the two fixed side plates of the fixed box 3, ensuring good lateral guidance and constraint during movement.

The slope adjustment actuator 4 refers to an actuator configured to directly drive the lifting box 2 to achieve changes in a slope gradient of the lifting box 2. The bottom portion of the slope adjustment actuator 4 refers to a portion of the slope adjustment actuator 4 along the negative Z-axis direction.

The inclination adjustment reaction devices 5 refer to specialized components or systems used to counteract additional forces, moments, or loads generated during an inclination adjustment process of the movable bottom plate 203.

The pushing actuators 6 refer to actuators used to drive the movable bottom plate 203 to undergo relative displacement, thereby simulating the relative fault dislocation.

In some embodiments, the inclination adjustment reaction devices 5 are locked to the shaking table platen 101 via the fasteners 7 and located below the movable bottom plate 203 of the lifting box 2. Each of the inclination adjustment reaction devices 5 is provided with multi-angle holes 501. A bottom portion of each of the pushing actuators 6 is detachably connected to the multi-angle holes 501. A top portion of each of the pushing actuators 6 is detachably connected to a hinge head 209 at the bottom portion of the movable bottom plate 203 of the lifting box 2. Counts of the inclination adjustment reaction devices 5 and the pushing actuators 6 are four.

The multi-angle holes 501 refer to installation holes located at different heights on the inclination adjustment reaction device 5.

The bottom portion of each of the pushing actuators 6 refers to a portion of the pushing actuator 6 that connects to the inclination adjustment reaction device 5.

Detachable connection between the pushing actuator 6 and the multi-angle holes 501 may be achieved by a plurality of manners, such as pin shaft connection, or the like.

The hinge head 209 refers to a connecting portion located at the bottom portion of the movable bottom plate 203.

Detachable connection between the pushing actuator 6 and the hinge head 209 may be achieved by a plurality of ways, such as spherical hinge connection, clevis-pin hinge connection, or the like. Merely by way of example, when the spherical hinge connection is used, the top portion of the pushing actuator 6 is a spherical rod end, and the hinge head 209 is a bearing housing with an internal spherical socket. The spherical rod end of the pushing actuator 6 is screwed or inserted into the internal spherical socket of the hinge head 209 and secured via a fastener to achieve the connection.

The hinge head 209 and a joint at the top portion of the pushing actuator 6 cooperate to form a rotatable hinged connection. The connection allows the pushing actuator to swing freely as the angle of the lifting box 2 changes during a pushing process, thereby avoiding the generation of lateral bending forces.

In some embodiments, as shown in FIG. 1, both ends of each of the slope adjustment actuator 4 and the pushing actuators 6 are provided with dampers 10.

The dampers 10 refer to devices or components used to dissipate motion energy, suppress vibration, or mitigate impact. In some embodiments, the dampers are high-frequency dampers, i.e., passive vibration damping devices used to absorb high-frequency vibration energy. The high-frequency vibration energy refers to kinetic energy carried by vibrations with relatively high frequencies (typically higher than a main operating frequency or natural frequency of the shaking table 1).

In some embodiments of the present disclosure, by installing high-frequency dampers, the impact interference from high-frequency vibrations of the shaking table 1 on slope adjustment can be effectively filtered out, which prevents slight vibrations of the actuators (crawling phenomenon), ensuring the smoothness and control precision of the dislocation process.

In some embodiments, by operating the slope adjustment actuator 4 to jack up the lifting box 2, slope models with different gradients may be simulated. The experimental device further includes a fixed steel rod 8. Both ends of the fixed steel rod 8 are respectively fixed to the lifting box 2 and the shaking table platen 101 via the fasteners 7. Dislocation tests with fault dip angles of 30°, 45°, 60°, and 90° may be simulated using the inclination adjustment reaction devices 5 and the pushing actuators 6. By operating the seismic motion excitation system and the bedrock fault dislocation system arranged on the shaking table 1 simultaneously, an experimental analysis of slope seismic damage under coupled action of ground motion and bedrock dislocation can be achieved.

The fixed steel rod refers to a steel rod used to establish rigid connection between the lifting box 2 and the shaking table platen 101. In some embodiments, the fixed steel rod may also be referred to as a high-strength fixed steel rod. In some embodiments, the high-strength fixed steel rod has a yield strength not less than 345 MPa.

When conducting experiments using the experimental device for analyzing seismic damage to a slope under coupled action of ground motion and bedrock dislocation according to the present disclosure, the following operations are included:
S1: locking the pre-assembled and welded fixed box 3 to the shaking table platen 101 via the high-strength bolts and nuts 7, and connecting the hinge bearing device 304 at the rear end of the bottom plate 303 to the shaking table platen 101 via the high-strength bolts and nuts 7.
S2: welding and fixing the support brackets 206 on both sides of the lifting box 2 to the reinforcing ribs of the side plates 202, and connecting the support brackets 206 to the slope adjustment actuator 4; locking the bottom portion of the slope adjustment actuator 4 to the shaking table platen 101 via the high-strength bolts and nuts); placing the movable bottom plate 203 steadily on the high-strength angle steels 205; sealing the installation gaps between the movable bottom plate 203 and each of the fixed bottom plate 204, the side plates 202, and the rear plate 201 using visible thick polyethylene plastic sheeting; hoisting the lifting box 2 using the hoisting rings 207, and hinging the bearing hinge interface 208 at the front end of the fixed bottom plate 204 of the lifting box 2 to the hinge bearing device 304 at the rear end of the bottom plate 303 of the fixed box 3 on the shaking table platen 101.
S3: jacking up the lifting box 2 using the slope adjustment actuator 4 to reach the slope gradient required for a slope model test; fixing both ends of the high-strength fixed steel rod 8 to the lifting box 2 and the shaking table platen 101 via the high-strength bolts and nuts 7; filling the lifting box 2 and the fixed box 3 with model soil or other model materials and arranging the pressure sensors 11 until the desired height is reached.
S4: locking the four inclination adjustment reaction devices 5 to the shaking table platen 101 via the high-strength bolts and nuts 7; installing the pushing actuators 6 according to a required fault dislocation dip angle (i.e., an installation inclination angle).
S5: operating the shaking table 1 and the pushing actuators 6 simultaneously, thereby realizing the process of slope instability and failure under the coupled action of ground motion and bedrock dislocation.

The present disclosure enables large-scale slope model testing under the coupled action of both ground motion and bedrock dislocation, which can provide technical support for the seismic fortification of actual slope engineering. The present disclosure allows for convenient realization of slope models with different gradients through the slope adjustment actuator, saving manpower and materials while offering high fidelity and authenticity. The present disclosure allows for conducting dislocation tests with different fault dip angles based on a slope with a certain gradient, featuring simple operation and rich test conditions. The experimental results obtained using the device of the present disclosure can, to some extent, reveal the deformation patterns and instability mechanisms of slopes under seismic action, promoting the development and innovation of dynamic theory for slopes across faults under seismic action.

In some embodiments, as shown in FIGS. 1, 2 and 4, an inner side of each of the side plates 202 is provided with a pressure sensor 11 configured to monitor lateral earth pressure in real time. The experimental device further includes a control terminal 12. The control terminal 12 is configured to: receive the lateral earth pressure; and reduce a pushing speed of the pushing actuators 6 when the lateral earth pressure exceeds a preset safety threshold.

The pressure sensor 11 is configured to convert thrust exerted by the soil within the lifting box 2 on the side plates 202 into standardized electrical signals (e.g., a voltage signal, a current signal, or a digital signal) to obtain the lateral earth pressure.

In some embodiments, there are a plurality of pressure sensors 11. For example, as shown in FIG. 2 and FIG. 4, the pressure sensors 11 include four pressure sensors respectively arranged at corresponding positions on the two side plates 202.

The lateral earth pressure refers to a normal thrust that is perpendicular to the surface of the side plates 202 and is generated by the slope model under self-weight and external forces (such as ground motion or fault pushing) on the side plates 202 of the lifting box 2.

The control terminal 12 may be set up independently from the shaking table 1 to avoid malfunctions caused by vibrations.

In some embodiments, the control terminal 12 includes a processor and a communication component.

The processor may process data and/or information obtained from other devices or system components (such as the seismic motion excitation system and the bedrock fault dislocation system). Based on the data, information, and/or processing results, the processor may execute program instructions to perform one or more functions described in the present disclosure. In some embodiments, the processor may include one or more sub-processing devices (e.g., single-core processing devices or multi-core, multi-chip processing devices). Merely by way of example, the processor may include a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field-Programmable Gate Array (FPGA), a Programmable Logic Device (PLD), a controller, a microcontroller unit, a Reduced Instruction Set Computer (RISC), a microprocessor, or any combination thereof.

The communication component is configured to communicate with the seismic motion excitation system and the bedrock fault dislocation system. For example, the communication component may communicate with the pressure sensors 11, the pushing actuators 6, the shaking table platen 101, or the like. Merely by way of example, the communication component may receive the lateral earth pressure from the pressure sensors 11.

The preset safety threshold refers to an upper limit value of the lateral earth pressure set to prevent overloading of the box structure of the lifting box 2. The preset safety threshold may be set based on practical requirements.

The pushing speed refers to an instantaneous motion rate at which a piston rod (or push rod) of each of the pushing actuators 6 extends along an axial direction of the pushing actuator 6 to simulate bedrock fault dislocation. For example, the pushing speed may be 2 mm/s. The axial direction of the pushing actuator 6 refers to a straight-line direction defined by a central axis of a cylinder and a piston rod of the pushing actuator 6.

In some embodiments, when the lateral earth pressure exceeds the preset safety threshold, the control terminal 12 may reduce the pushing speed of the pushing actuator 6 in a plurality of ways. For example, the control terminal 12 may set a speed reduction amount that is positively correlated with the lateral earth pressure. The speed reduction amount refers to a numerical value or proportion by which the pushing actuator 6 reduces a current pushing speed of the pushing actuator 6.

In some embodiments, the control terminal 12 is further configured to: when the lateral earth pressure satisfies a preset condition, obtain a vibration acceleration of the shaking table platen 101 for a future time period; determine an adjustment timing based on the vibration acceleration; and adjust the pushing speed of the pushing actuators 6 at the adjustment timing.

The preset condition refers to a pre-defined condition related to judging the lateral earth pressure. For example, the preset condition may be that a rate of increase of the lateral earth pressure over the future time period exceeds a preset value. The rate of increase of the lateral earth pressure refers to a rate of change of the lateral earth pressure over time. The control terminal 12 may record the lateral earth pressure value collected by the pressure sensors 11 each time along with timestamp. Over consecutive small-time intervals (e.g., 0.1 seconds), the pressure change may be determined and then the rate of increase of the lateral earth pressure may be determined based on the time interval and the pressure change. The preset value may be set based on practical requirements.

The future time period refers to a period of time from the current time forward. For example, the future time period may be the next 5 minutes, the next 10 minutes, or the like.

The vibration acceleration refers to an acceleration of motion generated by the shaking table platen 101 during the future time period. The motion of the shaking table platen 101 may be generated by the plurality of vertical actuators 102 and the horizontal actuator 103 working together.

In some embodiments, the control terminal 12 may pre-read driving signals (i.e., the bidirectional seismic motion input) for the future time period to obtain the vibration acceleration of the shaking table platen 101 for the future time period. The driving signals refer to digital command sequences sent by the control terminal 12 to the pushing actuators 6. The driving signals may include time-vibration acceleration correspondence, time-velocity correspondence, time-displacement correspondence, or the like. After obtaining the driving signals, the control terminal 12 may parse or determines the driving signals to obtain the corresponding vibration acceleration.

The adjustment timing refers to a specific time point at which the pushing speed of the pushing actuators 6 is adjusted.

In some embodiments, the control terminal 12 may predict the adjustment timing based on the vibration acceleration of the shaking table platen 101 for the future time period. For example, the control terminal 12 may, based on the vibration acceleration of the shaking table platen 101 for the future time period, set a time point that is a preset duration (e.g., 5 ms) before the vibration acceleration reaches a peak as the adjustment timing, and issue an adjustment command to counteract the lag effect caused by inertia. The preset duration may be preset based on practical requirements.

In some embodiments, after determining the adjustment timing, the control terminal 12 may obtain the lateral earth pressure at the adjustment timing, then determine a speed reduction amount based on the lateral earth pressure, and subsequently adjust the pushing speed. More descriptions may be found in the related descriptions above.

In some embodiments of the present disclosure, predictive compensation is employed to actively offset interference from vibration inertia on the dislocation process, thereby enabling the bedrock dislocation action to synchronize more precisely with the ground motion input and significantly improving the simulation accuracy and authenticity of the coupled test.

In some embodiments, the control terminal 12 is further configured to: determine a disturbance acceleration based on an installation inclination angle each of the pushing actuators 6 and the vibration acceleration; determine a compensation control sequence based on the disturbance acceleration and an experimental soil parameter; and drive the pushing actuators 6 to adjust the pushing speed based the compensation control sequence.

The installation inclination angle refers to an angle between the axial direction of the pushing actuators 6 and a horizontal plane. For example, the installation inclination angle may be 30°, 45°, or the like. In some embodiments, the installation inclination angle may be obtained in a plurality of ways. For example, the installation inclination angle may be directly measured using an inclination sensor. As another example, the installation inclination angle may be determines based on a connection position of the pushing actuator 6 to the multi-angle holes 501 on the inclination adjustment reaction device 5. The multi-angle holes 501 correspond to different installation inclination angles of the pushing actuator 6. The correspondence may be preset.

The disturbance acceleration refers to an acceleration component induced by the motion of the shaking table platen 101 and acting along the axial direction of the pushing actuator 6.

In some embodiments, the control terminal 12 may, via a triaxial accelerometer (installed on or very close to the shaking table platen 101), measure the acceleration values of the shaking table platen 101 in three orthogonal directions (e.g., X-horizontal one, Y-horizontal two, Z-vertical) in real-time synchronously, and obtain a three-directional acceleration vector of the shaking table platen 101 as ax(t), ay(t), az(t). A spatial orientation angle of the pushing actuator 6 and a directional vector of an axis of the pushing actuator 6 in space may be determined based on the installation inclination angle of the pushing actuator 6. The disturbance acceleration is then determined by performing coordinate transformation and projection determinations based on the three-directional acceleration vector and the directional vector.

The experimental soil parameter refers to data characterizing a property of the soil tested in the lifting box 2. For example, the experimental soil parameter may include an equivalent mass of soil that participates in vibration, or the like. The equivalent mass of soil refers to a mass value of a concentrated mass point, which is equivalently simplified from the actual slope model with continuously distributed mass and has the same overall inertial effect. In some embodiments, the equivalent mass of soil that participates in vibration may be determined by measuring a density and a volume of the slope model before the test.

The compensation control sequence refers to a plurality of thrust commands or velocity commands generated to counteract the impact of the disturbance acceleration on the test. In some embodiments, the compensation control sequence may be represented by timestamps and speed adjustment amounts. For example, the compensation control sequence is ((0, 0), (1, −0.2), (2, −0.5), . . . , (20, +3.8)), indicating that at t=0 ms, the speed is reduced by 0 mm/s; at t=1 ms, the speed is reduced by 0.2 mm/s; and at t=20 ms, the speed is increased by 3.8 mm/s. The speed adjustment amount at a specific timestamp refers to an amount by which the speed at that timestamp is decreased/increased relative to an initial speed (i.e., the speed at t=0 ms).

In some embodiments, the control terminal 12 may determine a force required to counteract the disturbance acceleration by multiplying the disturbance acceleration by the equivalent mass of soil or convert the force into a corresponding speed adjustment amount, thereby obtaining the compensation control sequence.

In some embodiments, the control terminal 12 may adjust the pushing speed of the pushing actuators 6 according to the compensation control sequence. For example, assuming the pushing speed of the pushing actuators 6 is 10 mm/s at t=0 ms, then according to the compensation control sequence ((0, 0), (1, −0.2), (2, −0.5), . . . , (20, +3.8)), the pushing speed at t=1 ms would be 9.8 mm/s.

In some embodiments of the present disclosure, the interference imposed by the motion of the shaking table platen on the pushing actuators is effectively suppressed through precise dynamic decomposition and real-time compensation, thereby ensuring the independence and purity of the bedrock dislocation action and making the test results more accurately reflect the mechanism of the coupled interaction.

In some embodiments, each inner wall of the lifting box 2 and the fixed box 3 is provided with a flexible energy dissipation layer. The control terminal 12 is further configured to determine an energy dissipation parameter of the flexible energy dissipation layer based on the experimental soil parameter.

Each inner wall of the lifting box 2 and the fixed box 3 refers to a surface of each of all plates of the lifting box 2 and the fixed box 3 that faces inward and directly contact the experimental soil.

The flexible energy dissipation layer refers to a composite material layer attached to the inner walls of the boxes. The flexible energy dissipation layer is configured to dissipate stress wave energy. The material of the flexible energy dissipation layer may include high-damping rubber, viscoelastic polymer, special composite material, or the like. In some embodiments, the flexible energy dissipation layer may be adhered to the inner walls using a high-strength adhesive. The stress wave energy refers to mechanical energy that propagates in wave form within a soil medium due to sudden, dynamic loading (such as ground motion, fault dislocation, or impact), causing vibration, compression, and tension among the medium particles.

In some embodiments, the experimental soil parameter may further include a density of the vibrating soil, soil composition, shear wave velocity, or the like.

The energy dissipation parameter refers to a key physical and geometric parameter used to quantify and design the energy dissipation performance of the flexible energy dissipation layers and to ensure that the energy dissipation performance matches the dynamic characteristics of the experimental soil. For example, the energy dissipation parameter may include thickness and hardness of the flexible energy dissipation layer, or the like.

In some embodiments, the control terminal 12 may determine the energy dissipation parameter of the flexible energy dissipation layer by querying a database based on the experimental soil parameter. The database refers to a data repository that stores a correspondence between experimental soil parameter and the energy dissipation parameter. In some embodiments, the control terminal 12 may measure actual stress waves by installing sensors on the inner walls of the lifting box 2 and the fixed box 3. The control terminal 12 may then simulate, in batches, the performance of different combinations of the experimental soil parameters (e.g., the shear wave velocity, the density of vibrating soil) and different energy dissipation parameters (e.g., thickness and hardness of the flexible energy dissipation layer) under identical seismic waves. Thereby, a stress wave reflection coefficient for each parameter combination is monitored. A lower stress wave reflection coefficient indicates better energy dissipation performance. From the simulations, a specific combination of the experimental soil parameters and the energy dissipation parameter that yields the smallest stress wave reflection coefficient is selected for inclusion in the database. The stress wave reflection coefficient refers to a ratio of the stress wave energy reflected back into the soil at the soil-flexible energy dissipation layer-inner wall boundary to the original stress wave energy incident on the boundary. The shear wave velocity refers to a parameter used to characterize the ability of the soil in the slope model to resist shear deformation under seismic waves.

In some embodiments, the energy dissipation parameter includes a damping coefficient of the flexible energy dissipation layer, and the damping coefficient is negatively correlated with an energy dissipation distance.

The damping coefficient refers to a physical quantity characterizing the ability of the material of the flexible energy dissipation layer to dissipate vibration energy.

The energy dissipation distance refers to a vertical distance from a point within the flexible energy dissipation layer to a contact surface between the point and the experimental soil.

In some embodiments, the damping coefficient is negatively correlated with the energy dissipation distance, that is, a smaller energy dissipation distance corresponds to a larger damping coefficient.

In some embodiments of the present disclosure, the gradient-varying damping coefficient forms a wave impedance transition zone, which more gently absorbs and dissipates stress waves from the soil, avoids secondary reflections caused by abrupt impedance changes, and thereby further optimizes the simulation of the infinite domain boundary.

In some embodiments, the flexible energy dissipation layer is made of a rubber material with a closed-cell honeycomb structure or a microporous structure. A count of holes per unit area of a cross-section of the flexible energy dissipation layer is negatively correlated with the energy dissipation distance.

Merely by way of example, during a material preparation process, for an outer side of the flexible energy dissipation layer (near the box wall side), the energy dissipation distance is larger, corresponding to a smaller damping coefficient of the flexible energy dissipation layer. In this case, a smaller count of holes per unit area is required, making the material of the flexible energy dissipation layer denser. For an inner side of the flexible energy dissipation layer (near the soil side), the energy dissipation distance is smaller, corresponding to a larger damping coefficient of the flexible energy dissipation layer. In this case, an increased count of holes per unit area is required, making the material of the flexible energy dissipation layer more porous.

In some embodiments of the present disclosure, the employment of the closed-cell honeycomb structure or microporous structure of the flexible energy dissipation layer provides a specific and reliable industrial manufacturing scheme capable of achieving a gradient damping effect, thereby ensuring the stability and consistency of the performance of the flexible energy dissipation layer.

In some embodiments of the present disclosure, by intelligently matching the parameters of the energy dissipation layer with the experimental soil parameter, the simulation of the boundary conditions is optimized, which significantly weakens the wave reflection effect at the box walls (the “boundary effect”), makes the stress field inside the slope model closer to the real situation of a semi-infinite foundation, and thereby enhances the simulation fidelity of the test.

In some embodiments of the present disclosure, through real-time monitoring by the pressure sensors and automatic feedback control by the control terminal, structural deformation or damage of the lifting box caused by excessive lateral earth pressure can be effectively prevented, thereby significantly improving the safety and reliability of the experimental device and ensuring the feasibility of long-term repeated testing.

The embodiments described above are merely preferred implementations of the present disclosure and are not intended to limit the scope of the present invention. Without departing from the design spirit of the present invention, various modifications and improvements made to the technical solutions of the present invention by those of ordinary skill in the art shall fall within the protection scope defined by the claims of the present invention.

What is claimed is:

1. An experimental device for analyzing seismic damage to a slope under coupled action of ground motion and bedrock dislocation, comprising: a seismic motion excitation system based on a shaking table; and a bedrock fault dislocation system arranged on the seismic motion excitation system; wherein
the seismic motion excitation system includes the shaking table, a shaking table platen, a plurality of vertical actuators, and a horizontal actuator; wherein the plurality of vertical actuators are arranged on a lower surface of the shaking table platen, the horizontal actuator is arranged at an end of the shaking table platen, the plurality of vertical actuators and the horizontal actuator are fixed to the shaking table; the seismic motion excitation system is configured to realize bidirectional seismic motion input;
the bedrock fault dislocation system includes a lifting box and a fixed box, wherein the fixed box is fixed to the shaking table platen, the lifting box and the fixed box are hingedly connected with each other, the lifting box is provided with a slope adjustment actuator configured to jack up the lifting box to achieve a required slope gradient;
a bottom plate of the lifting box includes a movable bottom plate and a fixed bottom plate, and a relative fault dislocation is achieved by pushing the movable bottom plate of the lifting box with pushing actuators; the lifting box further includes a rear plate and side plates; the movable bottom plate is located at a rear side of the lifting box, and the fixed bottom plate is located at a front side of the lifting box, with installation gaps reserved between the movable bottom plate and each of the fixed bottom plate, the side plates, and the rear plate;
each of four corners of a bottom portion of the movable bottom plate is provided with angle steels;
each of both ends of the fixed bottom plate is fixedly connected to one of the side plates, a front end of the fixed bottom plate is provided with a bearing hinge interface configured to be hingedly connected to the fixed box;
each of the side plates is provided with a support bracket hingedly connected to the slope adjustment actuator, and a bottom portion of the slope adjustment actuator is locked to the shaking table platen via fasteners, and hoisting rings are fixed to reinforcing ribs at four corners of an upper portion of the side plates;
the fixed box includes a front box plate, fixed side plates, and a bottom plate, wherein the front box plate, the fixed side plates, and the bottom plate are fixedly connected to each other as a whole and locked to the shaking table platen via fasteners, a rear end of the bottom plate is provided with a hinge bearing device configured to be hingedly connected to the bearing hinge interface at the front end of the lifting box, and the bottom plate is connected to the shaking table platen via the fasteners;
after the lifting box is raised, the side plates of the lifting box are embedded within the fixed side plates of the fixed box; and
inclination adjustment reaction devices are locked to the shaking table platen via fasteners and located below the movable bottom plate of the lifting box, each of the inclination adjustment reaction devices is provided with multi-angle holes, a bottom portion of each of the pushing actuators is detachably connected to the multi-angle holes, and a top portion of each of the pushing actuators is detachably connected to a hinge head at the bottom portion of the movable bottom plate of the lifting box;
wherein counts of the inclination adjustment reaction devices and the pushing actuators are four.

2. The experimental device of claim 1, further comprising a fixed steel rod, wherein both ends of the fixed steel rod are respectively fixed to the lifting box and the shaking table platen via fasteners.

3. The experimental device of claim 1, wherein an inner side of each of the side plates is provided with pressure sensors configured to monitor lateral earth pressure in real time; the experimental device further comprises a control terminal configured to:
receive the lateral earth pressure; and
reduce a pushing speed of the pushing actuators when the lateral earth pressure exceeds a preset safety threshold.

4. The experimental device of claim 3, wherein the control terminal is further configured to:
when the lateral earth pressure satisfies a preset condition,
obtain a vibration acceleration of the shaking table platen for a future time period;
determine an adjustment timing based on the vibration acceleration; and
adjust the pushing speed of the pushing actuators at the adjustment timing.

5. The experimental device of claim 3, wherein the control terminal is further configured to:
determine a disturbance acceleration based on an installation inclination angle of each of the pushing actuators and a vibration acceleration;
determine a compensation control sequence based on the disturbance acceleration and an experimental soil parameter; and
drive the pushing actuators to adjust the pushing speed based on the compensation control sequence.

6. The experimental device of claim 3, wherein each inner wall of the lifting box and the fixed box is provided with a flexible energy dissipation layer, and the control terminal is further configured to:
determine an energy dissipation parameter of the flexible energy dissipation layer based on an experimental soil parameter.

7. The experimental device of claim 6, wherein the energy dissipation parameter includes a damping coefficient of the flexible energy dissipation layer, the damping coefficient being negatively correlated with an energy dissipation distance.

8. The experimental device of claim 6, wherein the flexible energy dissipation layer is made of a rubber material with a closed-cell honeycomb structure or a micro-porous structure, and a count of holes per unit area of a cross-section of the flexible energy dissipation layer is negatively correlated with an energy dissipation distance.

9. The experimental device of claim 1, wherein
lubrication material layers are coated on contact surfaces between the movable bottom plate and each of the side plates and the rear plate; or
rolling guide mechanisms are arranged at the installation gaps between the movable bottom plate and each of the side plates and the rear plate.

10. The experimental device of claim 1, wherein both ends of each of the slope adjustment actuator and the pushing actuators are provided with dampers.
